(19) United States
(12) Patent Application Publication
(10) Pub. No.: US 2004/0009703 A1
(43) Pub. Date: Jan. 15, 2004

(54) Connector assembly

(76) Inventor: Kraig P. Whiting, Angola, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/195,819

(22) Filed: Jul. 15, 2002

(51) Int. Cl. H01R 13/58

(52) U.S. Cl. 439/606

(57) ABSTRACT

An assembly for electrically connecting a towing vehicle to a towed vehicle includes an inner body, a terminal extending from the inner body, a conductor coupled to the terminal, an outer body substantially enclosing the inner body, the conductor, and the terminal, and a receptacle for receiving the outer body. The outer body includes at least one ridge formed on an outer surface of the outer body, and a locking member to cooperate with a lid of the receptacle to lock the outer body in the receptacle.

### FIELD OF THE INVENTION

The present invention relates to a connector assembly; in particular, a connector assembly for electrically connecting a towing vehicle to a towed vehicle or trailer.

### BACKGROUND AND SUMMARY OF THE INVENTION

Connector assemblies for connecting towing vehicles to trailers, which permit trailer brake lights, running lights, and other electrical functions to operate in tandem with the towing vehicle, are well known. See, for example, U.S. Pat. No. 4,770,644 to Feder, U.S. Pat. No. 5,514,009 to Hughes, U.S. Pat. No. 5,626,479 to Hughes, U.S. Pat. No. 5,800,188 to Barber et al., and U.S. Pat. No. 6,048,224 to Kay.

Traditionally, such connector assemblies are constructed by attaching “V” shaped brass spring clips to each connecting wire and to standing metal in the molding tool. PVC is molded around the entire assembly. During the molding operation, the spring clips expand. When the molded assembly is removed from the molding tool, the spring clips return to their closed position.

Also, connector assemblies of the prior art often include a locking mechanism to help maintain the electrical connection between the towed vehicle and towing vehicle during a towing operation. Commonly, a locking tab that abuts or engages a portion of the mating assembly, such as is shown in Hughes, U.S. Pat. No. 5,626,479, is used for this purpose. Such prior art locking tabs are disposed at a 90 degree angle from the outer surface of the connector assembly. Alternatively, as shown in Kay, U.S. Pat. No. 6,048,224, a locking member is provided for individual electrical contacts.

A disadvantage of this construction is that it is often difficult to insert the connector into the mating assembly. Also, forming the locking tab so that there is a 90 degree angle between the locking surface and the outer surface of the connector assembly does not result in a satisfactory or reliable “lock” with the mating assembly. Thus, the connector may become disconnected from the mating assembly during use.

The molding machine is typically a bottleneck in the process currently used to manufacture these products. It would be desirable to reduce the loading time at the molding machine to maintain a substantially continuous operation of the machine, thereby maintaining the mold at a desired temperature and increasing the production output. Also, due to the current manufacturing processes, the terminal positions in the final products are often inconsistent. Further, due to the large mass of cooling PVC during manufacture, out of round conditions can occur in the molded head.

An improved assembly for electrically connecting towing vehicles to towed vehicles, directed to eliminating the above-described shortcomings and other disadvantages of the prior art, is desired.

In accordance with the present invention, an assembly for electrically connecting a towing vehicle and a towed vehicle is provided, including an inner body, a terminal extending outwardly from the inner body, a conductor coupled to the terminal, and an outer body surrounding the inner body, terminal, and conductor, the outer body including a locking member extending outwardly from the outer body along a longitudinal axis of the outer body, the locking member including a locking surface formed to meet the longitudinal axis of the outer body at an acute angle.

Also in accordance with the present invention, an assembly for electrically connecting a towing vehicle and a towed vehicle is provided, including a sub-assembly including an inner body, a plurality of flat terminals, each having a fixed location with respect to the inner body and extending outwardly from the inner body, and a plurality of quick disconnect terminals, each coupled to one of the flat terminals, and an outer body molded over the sub-assembly, the outer body including a locking member disposed along a longitudinal axis of the outer body and extending outwardly therefrom.

Further in accordance with the present invention, an assembly for electrically connecting a towing vehicle and a towed vehicle is provided, including an inner body, a plurality of terminals extending outwardly from the inner body, a plurality of conductors, each coupled to a terminal, and an outer body substantially surrounding the inner body and the terminals, the outer body having a thickness of about 0.1 inches.

Yet further in accordance with the present invention, a method for manufacturing a connector assembly is provided. The method includes the steps of creating a sub-assembly including an inner body, a plurality of flat terminals extending outwardly from the inner body, and a plurality of quick disconnect terminals, each coupled to a flat terminal, placing the sub-assembly in a molding apparatus, and over molding the sub-assembly with a thin outer body.

Also in accordance with the present invention, a connector assembly is provided, including a sub-assembly having an inner body, a plurality of terminals extending outwardly from the inner body, and an outer body substantially surrounding the sub-assembly including a locking member extending outwardly from an outer surface of the outer body and at least one ridge having a length extending longitudinally along the outer surface, and a height that increases along at least a portion of the length.

Still further in accordance with the present invention, a mating assembly is provided for coupling a towing vehicle and a towed vehicle having a connector assembly, the connector assembly having a locking member, the locking member having a locking surface forming an acute angle with a longitudinal axis of the connector assembly, the mating assembly including a receptacle sized to receive the connector assembly, and a lid pivotally coupled to the receptacle, the lid having a locking portion formed to mate with the locking member of the connector assembly.

The features and advantages of the present invention described above, as well as addition features and advantages, will be readily apparent to those skilled in the art upon reference to the following description and the accompanying drawings.

### BRIEF DESCRIPTION OF THE DRAWINGS

FIG. 1 A shows a perspective view of an embodiment of a sub-assembly of the connector assembly of the present invention.

FIG. 1B shows a perspective view of an embodiment of the connector assembly of the present invention after completion of the molding process.

FIG. 2 shows a cross-sectional view of a connector assembly of the prior art in a molding tool of the prior art.

FIG. 3 shows a top view of the connector assembly of FIG. 1B in a molding tool, with the top half of the molding tool removed.

FIG. 4A shows a front view of one embodiment of the connector assembly of the present invention.

FIG. 4B shows a front view of an alternative embodiment of the connector assembly of the present invention.

FIG. 5A shows a perspective view of an embodiment of a locking mechanism on a lid of the mating assembly of the present invention.

FIG. 5B shows a perspective view of an alternative embodiment of a locking mechanism on a lid of the mating assembly of the present invention.

### DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

In accordance with the present invention, an improved towing vehicle-towed vehicle connector assembly, locking mechanism and method of manufacture are provided. Currently preferred embodiments of various aspects of the present invention are illustrated in the accompanying drawings and described below. One of ordinary skill in the art would readily understand that variations on the illustrated embodiments are possible that nonetheless incorporate the underlying concepts of the present invention, and therefore, such variations fall within the scope of the claims set forth below. Also, it is understood that the specific dimensions recited herein as relating to specific embodiments are not considered limiting, unless the claims expressly state otherwise. Further, one of ordinary skill in the art will appreciate that no element described herein is considered a required element of the present invention, unless one or more of the appended claims expressly recites that element.

Referring to FIG. 1A, a connector assembly adapted to mate with a mating assembly to electrically connect a towed vehicle to a towing vehicle includes an inner body 10, which has a first end 6 and a second end 8. Inner body 10 is substantially cannularly shaped in the illustrated embodiment. In one embodiment, inner body 10 is a plastic block or cylinder.

In the illustrated embodiment, a plurality of apertures 34 (as shown, a total of six) are arranged generally circularly around a central aperture 36, in first end 6 of inner body 10. This configuration of apertures corresponds to a current industry standard for connector assemblies that electrically connect towed vehicles to towing vehicles. However, one of ordinary skill in the art will readily understand that any number of apertures 34, 36 may be used, as needed for a particular application or circumstance.

One or more flat terminals 12, each having a first end 11 a positioned in a fixed location in inner body 10, extend outwardly from inner body 10. Although not shown in the figures, terminals 12 extend into inner body 10 in apertures 34 and contact or mater with corresponding terminals of a receptacle for receiving the connector assembly as is further described below. For ease of illustration, three flat terminals 12 are shown in FIG. 1A, but it is understood that the number and locations of flat terminals 12 corresponds to the number and arrangement of apertures 34, described above. In this way, flat terminals 12 may be interconnected with a similarly configured mating assembly via apertures 34.

A first end 13a of each of a plurality of quick disconnect terminals 14 is coupled to a second end 11b (not shown) of each of flat terminals 12 at a distance beyond second end 8 of inner body 10. In one embodiment, first ends 13a of quick disconnect terminals 14 are slid onto second ends 11b of flat terminals 12. While three quick disconnect terminals 14 are shown in FIG. 1A for ease of illustration, the actual number of quick disconnect terminals 14 is determined by the number of corresponding flat terminals 12 used in the particular application or circumstance.

The second ends 13b of quick disconnect terminals 14 are coupled to first ends 15 of wire conductors 16 to provide an electrically conductive path from flat terminals 12 to wire conductors 16. While three wire conductors 16 are shown in FIG. 1A, the actual number and configuration of wire conductors 16 is determined by the number and configuration of corresponding quick disconnect terminals 14. Wire conductors 16 transfer electricity from a power source on the towing vehicle to brake lights, running lights, and/or other electrically operated components of the towed vehicle/trailer. Wire conductors 16 (except for first ends 15) are substantially housed within cable 18.

This design, which eliminates the use of “V” clips, allows for the economical custom plating of the metal stampings, which are exposed to the elements after installation on a trailer or towed vehicle. Traditionally, these stampings are made of un-plated brass, because the shape and nature of the “V” clips prevents custom plating (such as gold plating). The ability to custom plate these stampings may result in improved conductivity.

The above-described apparatus, including inner body 10 and terminals 12, 14, may be referred to as a sub-assembly 2 of the connector assembly of the present invention. During manufacturing, sub-assembly 2 is assembled first, before being moved to a molding machine to be over molded as described below. This method of manufacturing may result in improved efficiency because labor time loading the molding machine is reduced. Also, molding cycle time may be shortened as a result of creating sub-assembly 2 prior to molding, because doing so allows the molding machine to maintain a relatively constant temperature throughout a substantially continuous production run.

Sub-assembly 2 is over molded with a coating material to form outer body 20, shown in FIG. 1B. In one embodiment, a thin coating of PVC, with a thickness of about 0.1 inch (subject to manufacturing tolerances), is used to form outer body 20. Use of only a thin coating in such embodiment may reduce the dimensional variance in the terminal(s), because less coating material (i.e., PVC) is used and subsequently cooled.

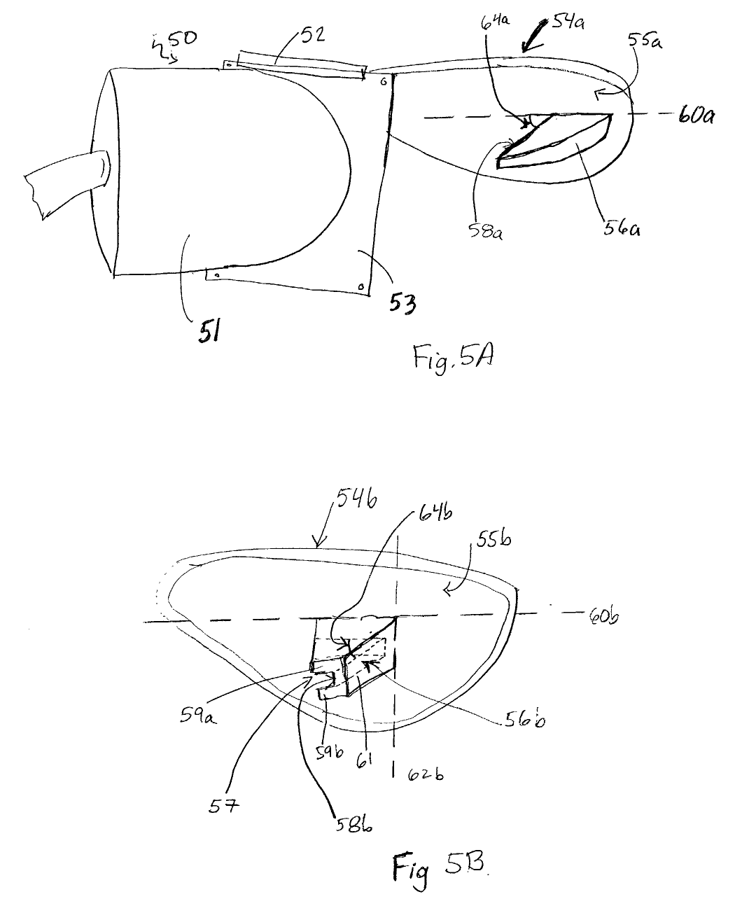

As shown in FIG. 1B, the final, molded connector assembly includes an outer body 20 having a first end 28, a second end 29, and an integrally formed lock tab 22 positioned nearer to second end 29. In the illustrated embodiment, lock tab 22 includes a locking surface 24, which forms an acute angle 27 with longitudinal axis 31 of outer body 20. In such embodiment, when outer body 20 is inserted into a mating connector, a flap, lid or cover (FIGS. 5A, 5B) latches over surface 24. Since surface 24 forms less than a 90° angle with longitudinal axis 31, it secures the connector assembly and the mating assembly and resists removal of the connector assembly in direction A.

Also shown in FIG. 1B are ridges 26. Many mating assemblies or receptacles are formed to provide a cylindrical cavity for receiving outer body 20. As a result of the receptacle molding process, such cavities typically have an inner diameter that decreases slightly with distance from the open end of the cavity to the end wall of the cavity. Ridges 26 may provide a more “snug” fit upon full insertion of outer body 20 into a mating assembly or receptacle. Thus, in certain embodiments, outer body 20 includes ridges 26 that have a length extending longitudinally along the outer surface of outer body 20. Ridges 26 also have a height relative to the outer surface of outer body 20 that increases along the length of ridges 26. This “tapering” of ridges 26 effectively increases the outer diameter of outer body 20 with the distance from first end 28 of outer body 20 toward second end 29. The height of ridges 26 increases along the length of the ridge 26, so that ridges 26 have a smaller height nearer to first end 28 and a greater height nearer to second end 29 of outer body 20. “Height” as used in this paragraph refers to the outwardly projected portion of ridges 26, directed radially away from outer body 20, which effectively increases the outer diameter of outer body 20.

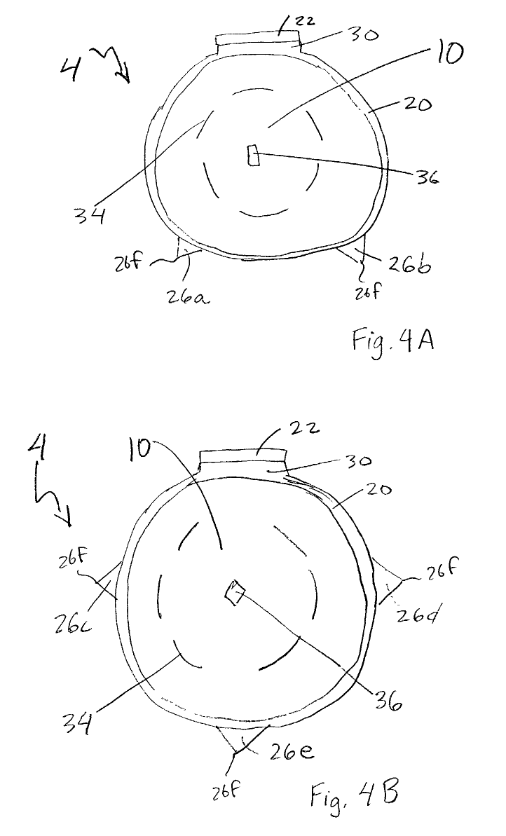

As shown in FIGS. 4A and 4B, ridges 26 can be formed on outer body 20 in a variety of configurations. For example, FIG. 4A shows an embodiment having two ridges 26a,b located substantially on a bottom portion of outer body 20, opposite locking member 22. As another example, FIG. 4B shows an embodiment having three ridges 26c,d,e, with two of the ridges 26c,d being located approximately 180 degrees opposite one another, and the third ridge 26e positioned between the first two ridges. The third ridge 26e is, in one embodiment, positioned at an equal distance from the first two ridges 26c,d. As shown in FIGS. 4A-B, ridges 26a-e may be substantially triangular in shape having an edge 26f. Alternatively, as shown in FIG. 1B, ridges 26 may have a flat upper surface 26g. Of course, the upper surface of any of the ridges may also be curved, rounded, or any other suitable shape.

Locking ridge 30 is also shown in FIG. 1B. In the illustrated embodiment, locking ridge 30 is also formed during the molding process described above as part of outer body 20, and extends at one end from outer body 20 to form locking member 22. In certain embodiments, the portion of locking ridge 30 opposite locking member 22 may function like ridges 26 to provide a snug fit with a mating assembly or receptacle. In other embodiments, locking ridge 30 functions as a keying member, and is received by a correspondingly shaped indentation or groove portion of a mating assembly or receptacle to ensure that the terminals 12 of the connector assembly are properly oriented in the mating assembly to electrically connect a towed vehicle to a towing vehicle.

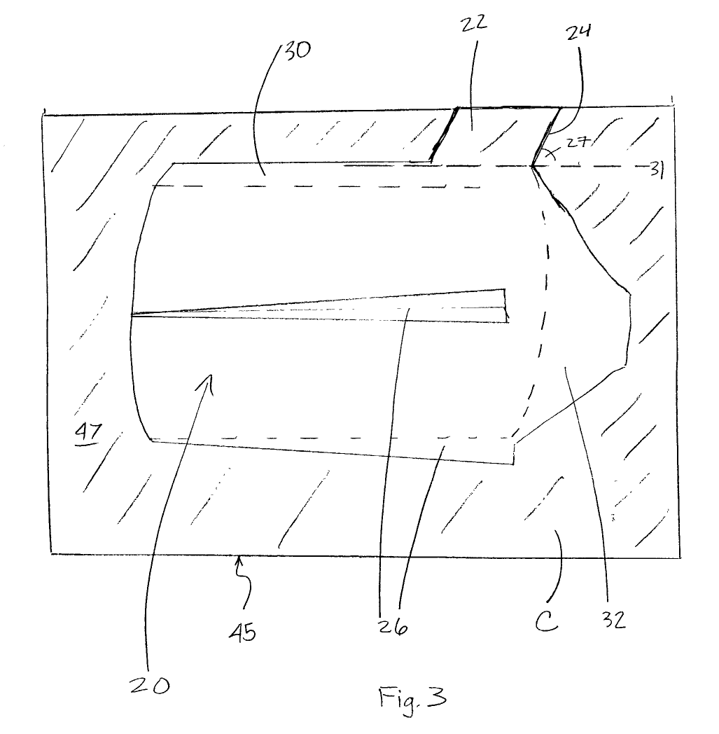

FIG. 1B also shows sheath 32. Sheath 32 surrounds at least a portion of wire conductors 16. Depending on the size and length of outer body 20, sheath 32 may be used to enclose and protect all or a portion of quick disconnect terminals 14 and flat terminals 12, as well. As shown in FIG. 3, sheath 32 is formed during the molding process described above as an extension of outer body 20. Alternatively, sheath 32 may be made of another suitable protective material, such as a heat-shrinkable polymeric material.

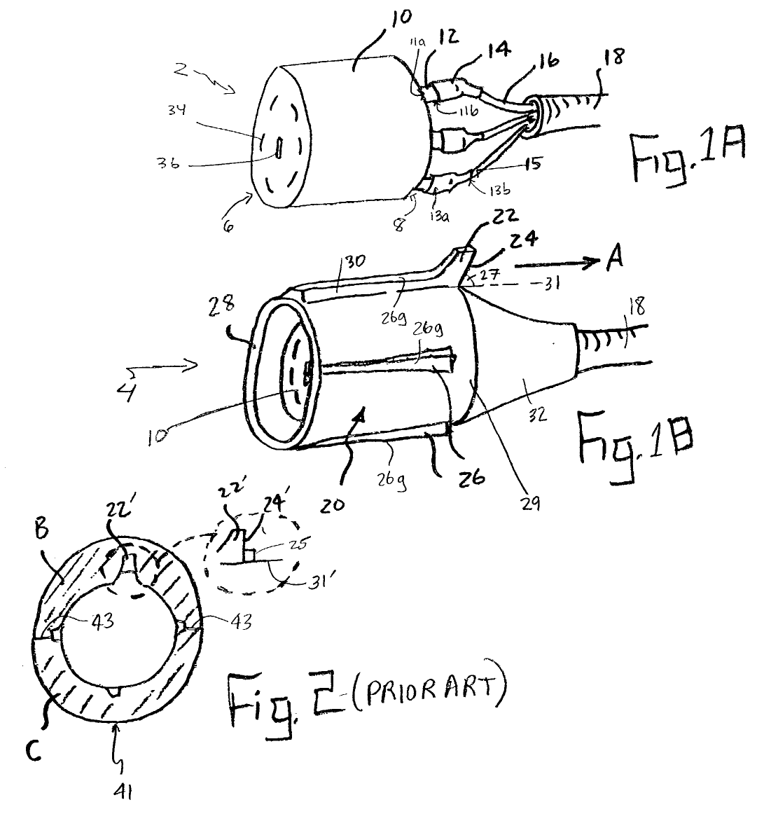

FIG. 2 is a cross-section of a prior art mold 41 for a conventional connector assembly body. As shown, locking member 22′ is oriented vertically relative to the interface 43 between the two halves B and C of mold 41. Accordingly, as shown in the side view inset of FIG. 2, angle 25 formed by surface 24′ and longitudinal axis 31′, using conventional techniques, is not less than 90°, to permit removal of mold portion B.

As shown in FIG. 3, in one embodiment of the present invention, the orientation of outer body 20 is rotated 90° in the mold 45, such that locking member 22 is disposed at the interface 47 between molding portions B and C (only portion C is shown). With this orientation, surface 24 may form an acute angle 27 with respect to longitudinal axis 31 of outer body 20, thereby providing the locking feature described above.

FIGS. 5A and 5B illustrate alternative embodiments of a locking portion of a mating assembly adapted to receive or mate with locking member 22. FIG. 5A shows a mating assembly 50, including a receptacle 51 and a lid 54a pivotally or hingedly coupled to a mount 53. The prior art is replete with examples of such receptacles, lids, and mounts, and one of ordinary skill in the art would readily be able to apply such examples to the present invention.

In accordance with the present invention, FIG. 5A shows a locking catch 56a formed or positioned on a bottom side 55a of lid 54a. Locking catch 56a has a mating surface 58a. Locking catch 56a is positioned or formed along a horizontal axis 60a so that when connector assembly 4 is inserted into the cavity (not shown) formed in receptacle 51, mating surface 58a abuts locking surface 24 of locking member 22. Mating surface 58a also forms an acute angle 64a with respect to bottom side 55a to correspond to angle 27 of locking surface 24.

FIG. 5B shows a locking member 56b formed or positioned on a bottom side 55b of an alternative embodiment of lid 54b (remainder of the mating assembly is not shown). A locking groove 57 is formed in locking member 56b by guide walls 59a,b and rear wall 61. Mating surface 58b is the surface of rear wall 61 that faces locking groove 57. Mating surface 58b forms an acute angle 64b with respect to bottom wall 55b of lid 54b that corresponds to angle 27 of locking surface 24. Accordingly, when connector assembly 4 is inserted into receptacle 51, locking groove 56b receives locking member 22 and mating surface 58b abuts locking surface 24.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed is:

1. An assembly for electrically connecting a towing vehicle and a towed vehicle, including:
an inner body;
a terminal extending outwardly from the inner body;
a conductor coupled to the terminal; and
an outer body surrounding the inner body, terminal, and conductor, the outer body including a locking member extending radially outwardly from the outer body, the locking member including a locking surface that forms an acute angle relative to a longitudinal axis of the outer body.

2. The assembly of claim 1, wherein the inner body includes a plurality of apertures.

3. The assembly of claim 1, wherein the inner body is substantially cylindrical.

4. The assembly of claim 1, wherein the terminal includes a flat terminal.

5. The assembly of claim 1, wherein the terminal includes a quick disconnect terminal.

6. The assembly of claim 1, wherein the outer body has a first end and a second end longitudinally spaced apart from the first end, and the locking member is positioned nearer to the second end.

7. The assembly of claim 1, wherein the outer body includes at least one ridge extending along a second longitudinal axis of the outer body.

8. The assembly of claim 7, wherein the outer body has a length extending from a first end to a second end longitudinally spaced apart from the first end, and the at least one ridge projects farther from an outer surface of the outer body with distance from the first end to the second end.

9. The assembly of claim 1, wherein the outer body comprises a thin layer of PVC.

10. The assembly of claim 1, wherein the outer body has a thickness of about 0.1 inch.

11. The assembly of claim 1, wherein the outer body includes a sheath substantially enclosing the terminal and the conductor.

12. The assembly of claim 1, wherein the outer body is over molded onto the inner body.

13. An assembly for electrically connecting a towing vehicle and a towed vehicle, including:
a sub-assembly including
an inner body,
a plurality of flat terminals, each having a fixed location with respect to the inner body and extending outwardly from the inner body,
a plurality of quick disconnect terminals, each coupled to a respective one of the flat terminals; and
an outer body molded over the sub-assembly, the outer body including a locking member extending radially outwardly from the outer body.

14. The assembly of claim 13, wherein the locking member has a locking surface that forms an acute angle with a longitudinal axis of the outer body.

15. The assembly of claim 13, wherein the sub-assembly further includes a plurality of conductors, each coupled to a respective one of the quick disconnect terminals.

16. An assembly for electrically connecting a towing vehicle and a towed vehicle, including:
an inner body;
a plurality of terminals extending outwardly from the inner body;
a plurality of conductors, each coupled to a terminal; and
an outer body substantially surrounding the inner body and the terminals, the outer body having a thickness of about 0.1 inches.

17. The assembly of claim 16, wherein the outer body is formed from PVC.

18. The assembly of claim 16, wherein the outer body substantially surrounds the conductors.

19. A method for manufacturing a connector assembly, including the steps of:
assembling a sub-assembly having an inner body, a plurality of terminals extending from the inner body, and a plurality of quick disconnect terminals, each coupled to a respective terminal;
placing the sub-assembly in a molding apparatus; and
over molding the sub-assembly with an outer body.

20. The method of claim 19, wherein the molding apparatus includes a mold portion in the shape of a locking member of the outer body having a locking surface that forms an acute angle with a longitudinal axis of the outer body.

21. The method of claim 20, wherein the mold portion is positioned at an interface between molding halves of the molding apparatus.

22. The method of claim 19, wherein the outer body is formed from PVC.

23. The method of claim 19, wherein the sub-assembly further includes a plurality of conductors, each coupled to a respective quick disconnect terminal.

24. A connector assembly, including:
a sub-assembly including
an inner body;
a plurality of terminals extending from the inner body; and
a plurality of conductors, each coupled to a respective one of the terminals; and
an outer body substantially surrounding the sub-assembly including a locking member extending outwardly from an outer surface of the outer body and at least one ridge having a length extending longitudinally along the outer surface, and a height relative to the outer surface that increased along at least a portion of the length of the ridge.

25. The connector assembly of claim 24, wherein the at least one ridge is substantially triangularly shaped.

26. The connector assembly of claim 24, wherein the outer body has a first end and a second end spaced apart from the first end, and the at least one ridge has a first height adjacent the first end that is less than a second height of the ridge adjacent the second end.

27. The connector assembly of claim 24, including a first ridge and a second ridge spaced apart from the first ridge.

28. The connector assembly of claim 27, wherein the first ridge is positioned 180 degrees from the second ridge.

29. The connector assembly of claim 28, further including a third ridge positioned between the first and second ridges.

30. The connector assembly of claim 29, wherein the third ridge is equidistant from the first and second ridges.

31. A mating assembly for coupling a towing vehicle and a towed vehicle having a connector assembly, the connector assembly having a locking member, the locking member having a locking surface, the locking surface forming an acute angle with a longitudinal axis of the connector assembly, the mating assembly including:
a receptacle sized to receive the connector assembly; and
a lid pivotally coupled to the receptacle, the lid having a locking portion formed to mate with the locking member of the connector assembly.

32. The mating assembly of claim 31, wherein the locking portion includes a catch formed to abut the locking surface of the locking member.

33. The mating assembly of claim 31, wherein the locking portion includes a groove configured to receive the locking member.

34. An assembly for electrically connecting a towing vehicle and a towed vehicle, including:
means for forming an inner body;
terminal means extending outwardly from the forming means for carrying an electrical signal;
means for coupling the terminal means to a conductor;
means for substantially enclosing the forming means, terminal means, and coupling means;
receptacle means for receiving the enclosing means including means for covering the receptacle means;
wherein the enclosing means including means for cooperating with the covering means to lock the enclosing means into the receptacle means, the locking means including a locking surface that forms an acute angle relative to a longitudinal axis of the enclosing means.
